(19) United States
(12) Patent Application Publication
(10) Pub. No.: US 2021/0380447 A1
(43) Pub. Date: Dec. 9, 2021

(54) SHOWER FILTER

(71) Applicant: MY CO.,LTD, Gwangju-si (KR)

(72) Inventor: Pyo SONG, Seoul (KR)

(21) Appl. No.: 17/113,727

(22) Filed: Dec. 7, 2020

Related U.S. Application Data
(63) Continuation of application No. PCT/KR2020/010473, filed on Aug. 7, 2020.

(30) Foreign Application Priority Data
Jun. 8, 2020 (KR) 10-2020-0069183

(51) Int. Cl. C02F 1/68; B05B 1/18; B05B 7/24

(52) U.S. Cl. CPC C02F 1/688; C02F 2307/06; B05B 7/2462; B05B 1/18

(57) ABSTRACT

A shower filter includes a water treatment gel composition containing 100 parts by weight of vitamin C or a vitamin C derivative, 100 parts by weight of salt, and 3 to 13 parts by weight of xanthan gum so that there are advantages of removing chlorine dissolved in service water and simultaneously providing natural minerals to skin to help skin care.

### TECHNICAL FIELD

The present invention relates to a shower filter which filters and softens service water transferred from a water supply apparatus and transfers the service water to a shower head.

### BACKGROUND ART

Generally, water used for face washing and bathing in a house is service water. The generally used service water is disinfected by adding a chlorine component in a water treatment facility, and the disinfected raw water is supplied to the house in a state in which the chlorine component remains therein.

The remaining chlorine dissolved in the raw water may react with sensitive skin to generate various types of skin trouble or carcinogens.

A filter is used in the house to remove the remaining chlorine dissolved in the service water. The filter generally used in the house uses a cation exchange resin and a filter to filter hard water by removing chlorine, calcium, magnesium, and the like contained in the service water so that the soft water is made.

The cation exchange resin contains a high concentration of sodium chloride. When the hard water containing cations such as calcium, magnesium, and the like passes through the cation resin, hardness components are replaced with sodium by ion exchange and adsorbed on the resin, and the sodium comes out to the water so that the soft water is made.

However, the cation exchange resin included in the conventional filter has disadvantages of a high cost, a short use lifetime, and low efficiency in removing residual chlorine.

### TECHNICAL PROBLEM

The present invention is directed to providing a shower filter having a long lifetime to solve the above-described problems.

In addition, the present invention is directed to providing a cheap shower filter.

In addition, the present invention is directed to providing a shower filter for helping skin care.

### TECHNICAL SOLUTION

One aspect of the present invention provides a water treatment gel composition containing 100 parts by weight of vitamin C or a vitamin C derivative, 100 parts by weight of salt, and 3 to 13 parts by weight of xanthan gum.

The water treatment gel composition may further contain 3 to 13 parts by weight of methyl cellulose, 3 to 13 parts by weight of dextrin, and 3 to 13 parts by weight of corn starch.

The water treatment gel composition may further contain at least one among a cudrania extract, a green tea extract, and a ledebouriellae radix extract, and powdered milk.

Another aspect of the present invention provides a method of preparing a water treatment ball including (1) a mixing operation of mixing 100 parts by weight of loess, 20 to 40 parts by weight of zeolite, and 5 to 30 parts by weight of fermented rice bran, (2) a pellet forming operation of forming pellets by inputting a mixture mixed through the mixing operation into a pill maker and rotating the mixture, and (3) a firing operation of firing the pellets formed through the pellet forming operation.

In addition, in the firing operation, the pellets may be primarily fired at a temperature of 180° C. to 250° C. for 0.5 to 3 hours and secondarily fired at a temperature of 350° C. to 700° C. for 0.5 to 2 hours.

### ADVANTAGEOUS EFFECTS

According to embodiments, a shower filter of the present invention has advantages of helping skin care by removing chlorine dissolved in service water and simultaneously providing natural minerals to skin.

In addition, the shower filter of the present invention has advantages of a small size and a long use lifetime.

In addition, the shower filter of the present invention has an advantage of being easily installed on a shower.

### DESCRIPTION OF DRAWINGS

FIG. 1 is a view illustrating an exterior of a shower filter of the present invention.

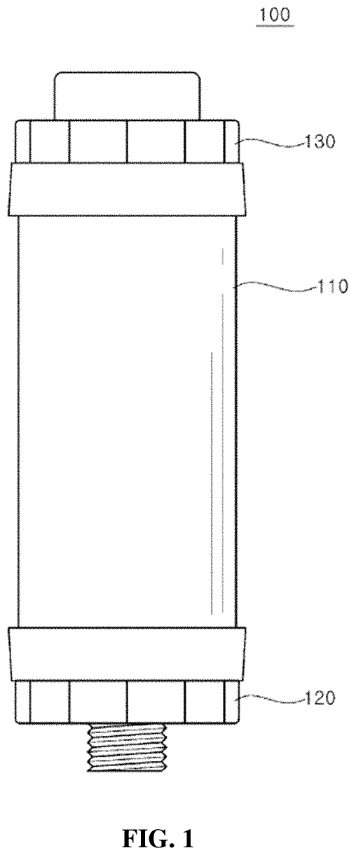

FIG. 2 is a view illustrating an interior of the shower filter of the present invention.

FIG. 3 is a view illustrating a water flow in the shower filter of the present invention.

FIG. 4 is a view illustrating a state in which the shower filter of the present invention is installed between a shower head and a shower hose.

FIG. 5 is a view illustrating a state in which the shower filter of the present invention is installed between a faucet and the shower hose.

### MODES OF THE INVENTION

In the present invention, service water refers to any water supplied from a water supply apparatus. For example, the service water may include groundwater, service water, seawater, and the like.

### Water Treatment Gel Composition

A water treatment gel composition according to one embodiment of the present invention may include vitamin C or a vitamin C derivative, salt, xanthan gum, methyl cellulose, dextrin, corn starch, and functional extracts.

The water treatment gel composition according to one embodiment of the present invention may be prepared through the following operations.

(1) 100 parts by weight of vitamin C or a vitamin C derivative and 100 parts by weight of salt are mixed, and the mixture is then mixed with 100 to 120 liters of water. Preferably, 30 to 40 kg of vitamin C and 30 to 40 kg of salt are mixed with 100 to 120 liters of water to prepare a mixed vitamin and salt solution.

(2) A viscosity-maintaining component is prepared. The viscosity-maintaining component is prepared by mixing 3 to 13 parts by weight of xanthan gum, 3 to 13 parts by weight of methyl cellulose, 3 to 13 parts by weight of dextrin, and 3 to 13 parts by weight of corn starch with water.

Preferably, 1 to 5 kg of xanthan gum and 10 to 20 liters of water are mixed for about 30 minutes using a mixer. Then, 1 to 5 kg of methyl cellulose and 10 to 20 liters of water are added thereto and mixed for 30 minutes using the mixer. Then, 1 to 5 kg of dextrin, 1 to 5 kg of corn starch, and 5 to 10 liters of water are added thereto and mixed to obtain a proper viscosity so that the viscosity-maintaining component is prepared.

(3) When the viscosity-maintaining component is added to the mixed vitamin and salt solution and the vitamin C or vitamin C derivative and salt is slowly dissolved in water, and a gel component in which the vitamin and salt are mixed is finally prepared.

In addition, an extract beneficial to skin may be added thereto according to an embodiment. The water treatment gel composition may further contain at least one among a cudrania extract, a green tea extract, and a ledebouriellae radix extract, and powdered milk.

The water treatment gel composition prepared through the above-described operations is transferred to a tank whose temperature is adjustable. A filled part 140, which will be described below, is filled with the water treatment gel composition using a filling machine of the tank. Preferably, a temperature of the filling machine is adjustable and a temperature of 40 to 70° C. in the filling machine is maintained so that a viscosity of the water treatment gel composition may be maintained during filling.

Preferably, the vitamin C contained in the water treatment gel composition of the present invention may be 35 to 45% of a total mass of the water treatment gel composition.

The salt contained in the water treatment gel composition of the present invention may remove chlorine dissolved in service water, and simultaneously, natural minerals dissolved in the salt are provided to the skin to help skin care during a shower.

Accordingly, since the water treatment gel composition of the present invention may provide the minerals to the skin with the vitamin C during a shower, there is an advantage of being more suitable for skin care when compared to the conventional shower filter containing only vitamin C.

In addition, in the present invention, pink salt, Dead Sea salt, sulfur-containing salt (black salt) which are rich in minerals may be used as the salt so that the salt may be more helpful to skin care when compared to simple sodium chloride contained in the conventional cation exchange resin.

### Water Treatment Ball

Water treatment balls according to one embodiment of the present invention may contain zeolite, loess, and rice bran extract.

The water treatment balls according to one embodiment of the present invention may be manufactured through the following operations.

(1) Rice Bran Fermentation Operation

Rice bran, a rice bran fermentation material, and water may be mixed to ferment the rice bran. The fermented rice bran may be prepared through this process.

According to one embodiment of the present invention, in order to prepare the fermented rice bran, 5 to 30 parts by weight of the rice bran fermentation material and 50 to 150 parts by weight of water based on 100 parts by weight of the rice bran may be mixed with the rice bran to ferment the rice bran. The fermentation material may include at least one among yeast, lactic acid bacteria, fermented liquor, and vinegar.

A mixture containing the above-described rice bran may be stirred at a temperature of 35 to 40° C. for 36 hours to 84 hours to prepare the fermented rice bran. Preferably, the mixture may be stirred at a temperature of 35 to 38° C. for 36 to 48 hours.

(2) Mixing Operation.

The rice bran fermented (hereinafter, fermented rice bran) through the rice bran fermentation operation may be mixed with loess and zeolite.

Preferably, 20 to 40 parts by weight of the zeolite and 5 to 30 parts by weight of the fermented rice bran based on 100 parts by weight of the loess may be input into a mixer and mixed for 30 to 60 minutes.

(3) Pellet Forming Operation

A bulk state material processed through the mixing operation may be input into a pill maker and rotated to form pellets in a cylindrical or spherical shape. The pellets formed as described above may be dried at a temperature of 10 to 40° C. for 0.5 to 5 hours.

In the case in which the pellets are formed as described above, there is an advantage in that a ratio of minerals extracted from the fermented rice bran is increased.

(4) Firing Operation

The pallets formed through the pellet forming operation may be primarily fired at a temperature of 180° C. to 250° C. for 0.5 to 3 hours, and secondarily fired at a temperature of 350° C. to 700° C. for 0.5 to 2 hours to form crystallized water treatment balls.

The water treatment balls formed through the above-described operation contain a large amount of natural minerals extracted from the rice bran.

Heavy metals and phosphorus may be adsorbed on the water treatment balls due to the zeolite contained in the water treatment balls, and hazardous substances, odors, and fluoride contained in the service water may be removed by a large amount of minerals contained in the fermented rice bran and the loess.

Particularly, a large amount of phytic acid components is contained in the natural minerals extracted from the rice bran. The phytic acid has a detox effect of removing pesticides, drugs, toxins from the body.

In addition, vitamin E and an antioxidant contained in the rice bran and the loess make the skin clear and smooth and have an excellent whitening effect.

In addition, antibacterial and ammonia deodorant effects may be obtained using the natural minerals contained in the rice bran and the loess. When the water treatment balls according to one embodiment of the present invention are used, effects of an ammonia deodorization rate of 95.9%, an antibacterial rate of 99.9%, and a far-infrared radiation emissivity of 92.5% may be obtained.

### Shower Filter

A shower filter 100 according to one embodiment of the present invention may include a filter body 110, a water inlet cap 120, a water outlet cap 130, a filled part 140, and a filter member 150.

(1) Filter Body 110

The filter body 110 accommodates the filled part 140 and the filter member 150 therein.

The filter body 110 and the filled part 140 are kinds of containers, and a filled housing 141 is filled with the water treatment gel composition therein.

The filter body 110 has a hollow form in which both of water outlet and inlet surfaces are open. For example, both of upper and lower surfaces of the filter body 110 are open and the filter body 110 may be a container having a circular or polygonal cross section. Preferably, the filter body 110 may be a cylinder of which both of upper and lower surfaces are open.

The water outlet surface refers to a surface at a side at which service water, on which water treatment is performed, is output, and the water inlet surface refers to a surface at a side at which service water containing foreign matter and heavy metals is supplied.

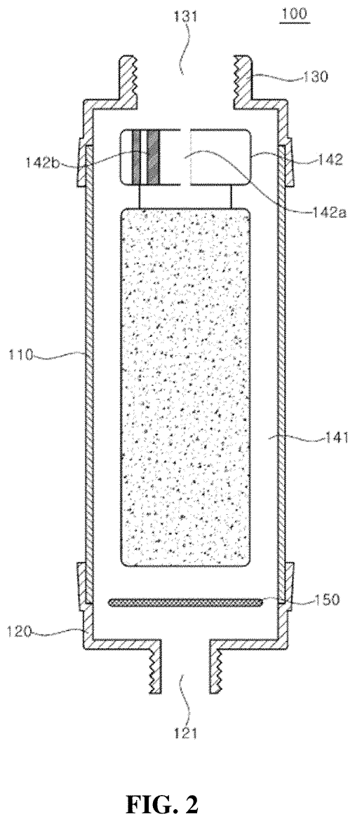

The filter member 150 and the filled part 140 are disposed in the hollow filter body 110. Referring to FIG. 2, the filter member 150 is disposed above the water inlet surface, and the filled part 140 is disposed above the filter member. The water outlet surface, the filled part 140, and the filter member 150 are sequentially disposed.

(2) Water Inlet Cap 120

The water inlet surface of the filter body 110 may be coupled to the water inlet cap 120 covering the water inlet surface and sealing at least a portion of the water inlet surface. As described above, the water inlet surface is a surface through which service water containing heavy metals is supplied, and the water inlet cap 120 performs a function of receiving the service water from the outside and transferring the service water to the filter body 110 and a function of covering and sealing the at least a portion of the water inlet surface.

A water inlet port 121 configured to receive service water from the outside is formed in the water inlet cap 120.

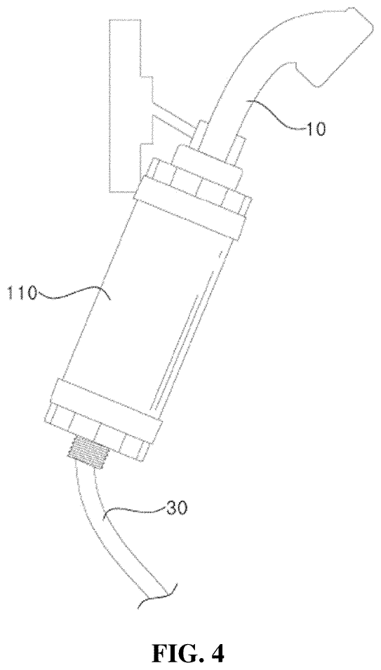

Referring to FIG. 4, the water inlet port 121 may be coupled to a shower hose 30 to receive service water through the shower hose 30 so as to transfer the service water into the filter body 110.

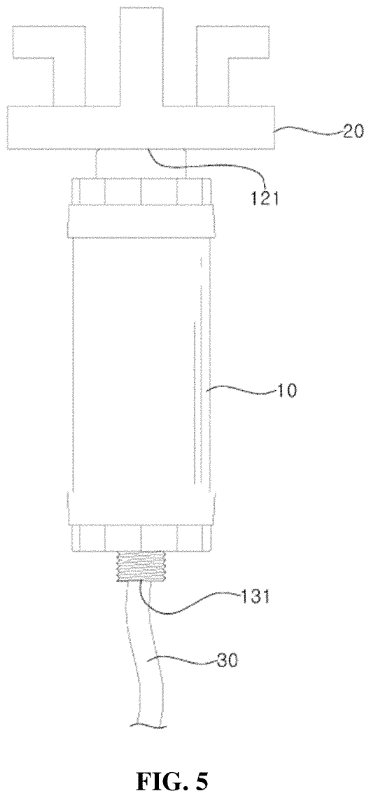

Alternatively, referring to FIG. 5, the water inlet port 121 may be coupled to a lower end of a faucet 20 to receive service water through the faucet 20 so as to transfer the service water into the filter body 110.

A cross section of a side, which is in contact with the filter body 110, of the water inlet cap 120 is the same as a cross section of the filter body 110, and an area of the cross section of the water inlet cap 120 is greater than an area of the cross section of the filter body 110 so that an outer surface of the filter body 110 is in contact with an inner surface of the water inlet cap 120.

The water inlet cap 120 is fixed to the filter body 110 through a high-speed fusion, bonding, or heat fusion process, or the like.

(3) Filter Member 150

According to a first embodiment of the present invention, the filter member 150 may be disposed between a lower portion of the filled part 140 and an upper portion of the water inlet cap 120.

Service water introduced through the water inlet port 121 may contain various kinds of foreign matter. The filter member 150 may filter the foreign matter contained in the introduced service water.

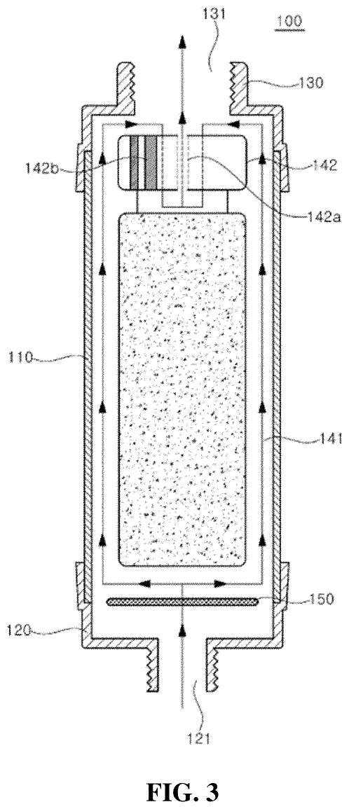

Referring to FIG. 3, the service water filtered by the filter member 150 moves toward the water outlet cap 130 along an outer surface of the filled housing 141 and an outer surface of a filled housing cap 142. While the filtered service water moves along an outer surface of the filled part 140, the filtered service water is not mixed with the water treatment gel composition filling the filled part 140 or water treatment balls.

According to a second embodiment of the present invention, the filter member 150 may include a first filter member and a second filter member.

The first filter member may be disposed between the lower portion of the filled part 140 and the upper portion of the water inlet cap 120. In addition, the second filter member may be disposed between an upper portion of the filled part 140 and an upper portion of the water outlet cap 130.

The first filter member may filter foreign matter contained in the service water introduced through the water inlet port 121.

The service water filtered by the first filter member moves toward the water outlet cap 130 along the outer surface of the filled housing 141 and the outer surface of the filled housing cap 142. While the filtered service water moves along the outer surface of the filled part 140, the filtered service water is not mixed with the water treatment gel composition or water treatment balls filling the filled part 140.

According to a third embodiment of the present invention, the filter member 150 may include a first filter member and a second filter member.

The first filter member may be disposed between the lower portion of the filled part 140 and the upper portion of the water inlet cap 120. In addition, the second filter member may be disposed between the upper portion of the filled part 140 and the upper portion of the water outlet cap 130.

The first filter member may filter foreign matter contained in the service water introduced through the water inlet port 121.

The service water filtered by the first filter member is introduced into the filled housing 141 and moves toward the water outlet cap 130. While the filtered service water is introduced into the filled part 140, the service water may be mixed with the water treatment gel composition or water treatment balls filling the filled part 140. In the above-described operation, fluorine in the service water is removed while ion exchange is performed between the fluorine and a large amount of minerals. In addition, other materials including the large amount of minerals contained in the water treatment gel composition or the water treatment balls are dissolved in the service water and moved toward the water outlet cap 130.

The service water moved toward the water outlet cap 130 may be secondarily filtered by the second filter member.

(4) Filled Part 140

The filled part 140 may include the filled housing 141 and the filled housing cap 142.

According to one embodiment of the present invention, the filled housing 141 is a kind of a container of which a lower surface is sealed and at least a portion of an upper surface is open and which is filled with the water treatment gel composition. A shape of a cross section of the filled housing 141 is the same as a shape of the cross section of the filter body 110, and an area of the cross section of the filled housing 141 is less than an area of the cross section of the filter body 110 so that the filled housing 141 may be accommodated in the filter body 110. The filled housing 141 may be formed of a material capable of preventing a component of the water treatment gel composition or the water treatment balls from being discharged to the outside, and preferably, may be formed of a polyethylene terephthalate (PET) material.

The filled housing cap 142 may be formed of a material that is the same as a material of the filled housing 141, may cover and seal the at least a portion of the upper surface of the filled housing 141, and simultaneously, may discharge some of the water treatment gel composition filling the filled housing 141.

Since a discharge hole 142a having a diameter of 0.02 to 0.1 mm is formed in the filled housing cap 142, the water treatment gel composition filling the filled housing 141 may be very slowly discharged so that there is an advantage in that a use lifetime thereof is increased when compared to the conventional shower filter.

Since a plurality of protrusions 142b are formed on the outer surface of the filled housing cap 142, in a case in which the filled part 140 is inserted into the filter body 110, the filled part 140 may be fixed so as not to move therein.

Preferably, the filter member 150 may be inserted into the filter body 110 first, the filled housing 141 filled with the water treatment gel composition may be inserted thereinto, and the filled housing cap 142 may be fixed to an open upper portion of the filled housing 141 to prevent the filled part 140 from moving in the filter body 110.

According to the first embodiment, a screw thread may be formed on an outer circumferential surface of the upper portion of the filled housing 141, and a screw groove may be formed in an inner surface of the filled housing cap 142 so that the filled housing 141 may be screw-coupled to the filled housing cap 142. Alternatively, a screw groove is formed in the outer circumferential surface of the upper portion of the filled housing 141 and a screw thread is formed on the inner surface of the filled housing cap 142 so that the filled housing 141 may be screw-coupled to the filled housing cap 142.

As the second embodiment, the filled housing 141 may be coupled to the filled housing cap 142 through a fusion process such as a thermal fusion process or a high-speed fusion process.

As the third embodiment, the filled housing 141 and the filled housing cap 142 may be coupled using an adhesive.

The filled housing 141 according to another embodiment of the present invention is a kind of a container of which at least a portion of a lower surface is open and at least a portion of an upper surface is open so that the water treatment gel composition fills the filled housing 141. The shape of the cross section of the filled housing 141 is the same as the shape of the cross section of the filter body 110, and an area of the cross section of the filled housing 141 is less than an area of the cross section of the filter body 110 so that the filled housing 141 may be accommodated in the filter body 110. The filled housing 141 may be formed of a material capable of preventing a component of the water treatment gel composition or the water treatment ball from being discharged to the outside, and preferably, may be formed of a PET material.

The filled housing cap 142 may be formed of a material that is the same as a material of the filled housing 141, may cover and seal the at least a portion of the upper surface of the filled housing 141, and may discharge some of the water treatment gel composition or a component of the water treatment balls filling the filled housing 141.

Since a plurality of protrusions 142b are formed on the outer surface of the filled housing cap 142, in a case in which the filled part 140 is inserted into the filter body 110, the filled part 140 may be fixed so as not to move therein.

Preferably, the filter member 150 or the first filter member is inserted into the filter body 110 first, the filled housing 141 filled with the water treatment gel composition may be inserted thereinto, and the filled housing cap 142 may be fixed to the upper portion of the filled housing 141 so that the filled part 140 may be prevented from moving in the filter body 110.

As the first embodiment, a screw thread may be formed on the outer circumferential surface of the upper portion of the filled housing 141, and a screw groove may be formed in the inner surface of the filled housing cap 142 so that the filled housing 141 may be screw-coupled to the filled housing cap 142. Alternatively, a screw groove is formed in the outer circumferential surface of the upper portion of the filled housing 141 and a screw thread is formed on the inner surface of the filled housing cap 142 so that the filled housing 141 may be screw-coupled to the filled housing cap 142.

As the second embodiment, the filled housing 141 may be coupled to the filled housing cap 142 through a fusion process such as a thermal fusion process or a high-speed fusion process.

As the third embodiment, the filled housing 141 and the filled housing cap 142 may be coupled using an adhesive.

(5) Water Outlet Cap 130

The water outlet cap 130 covering and sealing at least a portion of the water outlet surface may be coupled to the open water outlet surface of the filter body 110. In addition, a water outlet port 131 may be formed in the water outlet cap 130 to discharge service water, on which water treatment is performed, to the outside.

Referring to FIG. 4, the water outlet port 131 may be connected to a shower head 10 to transfer service water, on which water treatment was performed, to the shower head 10.

Alternatively, referring to FIG. 5, the water outlet port 131 may be coupled to a shower hose 30 through which service water is supplied to the shower head to transfer the service water, on which water treatment was performed in the filter body 110, to the shower head 10.

A shape of a partial surface of the water outlet cap 130 is the same as the shape of the cross section of the filter body 110, and an area of the partial surface of the water outlet cap 130 is greater than an area of the cross section of the filter body 110 so that an inner surface of the water outlet cap 130 is in contact with an outer surface of the filter body 110.

Referring to FIG. 3, the service water filtered by the filter member 150 moves toward the water outlet cap 130 along the outer surface of the filled housing 141 and the outer surface of the filled housing cap 142 which are formed of an impermeable material. In addition, the water treatment gel composition filling the filled housing 141 is also discharged through the discharge hole 142a which is a fine hole formed in the filled housing cap 142, moved toward the water outlet cap 130, and mixed with the service water filtered in the water outlet cap 130.

The service water primarily filtered by the first filter member may be introduced into the filled housing 141, mixed with the component of the water treatment gel composition or the water treatment balls, and moved toward the water outlet cap 130. While the service water is moved toward the water outlet cap 130, fluorine is removed, and the service water containing a large amount of minerals and components of other water treatment compositions or water treatment balls may be secondarily filtered by the second filter member. The secondary filtered service water is discharged toward the shower head 10 through the water outlet port 131.

The water outlet cap 130 is fixed to the filter body 110 through a high-speed fusion, bonding, or heat fusion process, or the like.

In the present invention, the filter body 110, the water inlet cap 120, the water outlet cap 130, and the filled housing 141 may be formed of impermeable materials, and preferably, may be formed of PET materials.

1. A water treatment gel composition comprising:
100 parts by weight of vitamin C or a vitamin C derivative;
100 parts by weight of salt; and
3 to 13 parts by weight of xanthan gum.

2. The water treatment gel composition of claim 1, further comprising:
3 to 13 parts by weight of methyl cellulose;
3 to 13 parts by weight of dextrin; and
3 to 13 parts by weight of corn starch.

3. The water treatment gel composition of claim 1, further comprising:
at least one among a cudrania extract, a green tea extract, and a ledebouriellae radix extract; and
powdered milk.

4. A shower filter comprising:
a filter body (110) configured to accommodate a filter member (150) and a filled part (140) filled with a water treatment gel composition;
a water inlet cap (120) coupled to a portion at a first position of the filter body (110) and including a water inlet port (121) configured to receive service water from the outside; and
a water outlet cap (130) coupled to a portion at a second position of the filter body (110) and including a water outlet port (131) configured to discharge the filtered and softened service water,
wherein the filter member (150) is disposed between a lower end of the filled part (140) and the water inlet cap (120) and filters the service water supplied through the water inlet cap (120), and
the filled part (140) includes a filled housing (141) which is filled with the water treatment gel composition and of which an upper portion is open, and a filled housing cap (142) which covers the upper portion of the open filled housing (141) and in which a discharge hole (142a), through which some of the water treatment gel composition filling the filled housing (141) is discharged, is formed.

5. The shower filter of claim 4, wherein the service water filtered by the filter member (150) is mixed with the water treatment gel composition in the water outlet cap (130) and discharged to a shower head (10) or a shower hose (30).

6. The shower filter of claim 4, wherein the water treatment gel composition comprises:
100 parts by weight of vitamin C or a vitamin C derivative;
100 parts by weight of salt; and
3 to 13 parts by weight of xanthan gum.

7. A method of preparing a water treatment ball, comprising:
(1) a mixing operation of mixing 100 parts by weight of loess, 20 to 40 parts by weight of zeolite, and 5 to 30 parts by weight of fermented rice bran;
(2) a pellet forming operation of forming pellets by inputting a mixture mixed through the mixing operation into a pill maker and rotating the mixture; and
(3) a firing operation of firing the pellets formed through the pellet forming operation.
